(19) United States
(12) Patent Application Publication
(10) Pub. No.: US 2006/0049595 A1
(43) Pub. Date: Mar. 9, 2006

(54) Electric skateboard

(76) Inventors: Daren W. Crigler, Florence, KY (US); Lawrence Talcott Diener, Long Beach, CA (US)

Correspondence Address: FROST BROWN TODD, LLC, 2200 PNC CENTER, 201 E. FIFTH STREET, CINCINNATI, OH, 45202, US

(21) Appl. No.: 11/219,159

(22) Filed: Sep. 2, 2005

Related U.S. Application Data
(60) Provisional application No. 60/522,223, filed on Sep. 2, 2004.

(51) Int. Cl. B62M 1/00

(52) U.S. Cl. 280/87.042

(57) ABSTRACT

An electric skateboard comprises a deck, a pair of rear wheels, and a front wheel having a front wheel diameter. A deck height is defined by the distance between the bottom side of the deck and the ground. The front wheel diameter is greater than the deck height. One or more motors is operable to drive the front wheel. A control module is in communication with the one or more motors, and is operable to effect acceleration and deceleration of the one or more motors. A rechargeable battery pack is configured to provide power to the one or more motors. A controller is in wireless communication with the control module. The controller is configured to receive user input and to transmit the user input to the control module.

### PRIORITY

This application claims priority from the disclosure of U.S. Provisional Patent Application Ser. No. 60/522,223, entitled “3 Wheeled Electric Skateboard,” filed Sep. 2, 2004.

### BACKGROUND OF THE INVENTION

Embodiments of the present invention relate to skateboards and similar devices. A variety of skateboards have been created and used, but no one prior to the inventor(s) has created or used the invention described in the appended claims.

### BRIEF DESCRIPTION OF THE DRAWINGS

While the specification concludes with claims that particularly point out and distinctly claim the invention, it is believed the present invention will be better understood from the following description taken in conjunction with the accompanying drawings, in which like reference numerals identify the same elements. The drawings and detailed description which follow are intended to be merely illustrative and are not intended to limit the scope of the invention as set forth in the appended claims.

FIG. 1 depicts a top view of a skateboard.

FIG. 2 depicts a side view of the skateboard of FIG. 1.

FIG. 3 depicts a bottom view of the skateboard of FIG. 1.

FIG. 4 depicts a top partial view of the skateboard of FIG. 1, showing a pan and its contents.

FIG. 5 depicts a partial view of the front wheel drive assembly of the skateboard of FIG. 1.

FIG. 6 depicts a remote control.

FIG. 7 depicts a front end view of the skateboard of FIG. 1 with a tilt.

FIG. 8 depicts a rear end view of the skateboard of FIG. 7.

FIG. 9 depicts a partial perspective view of an alternative front wheel drive assembly.

FIG. 10 depicts a partial view of an alternative front wheel drive assembly.

FIG. 11 depicts a partial side view of the front wheel drive assembly of FIG. 10.

FIG. 12 depicts a partial view of an alternative front wheel drive assembly.

FIG. 13 depicts a partial view of an alternative front wheel drive assembly.

FIG. 14 depicts a partial side view of the front wheel drive assembly of FIG. 13.

FIG. 15 depicts a partial side view of a skateboard having a suspension system.

FIG. 16 depicts an alternative remote control.

FIG. 17 depicts an alternative remote control.

### DETAILED DESCRIPTION OF EMBODIMENTS

The following description should not be used to limit the scope of the present invention. Other examples, features, aspects, embodiments, and advantages of the invention will become apparent to those skilled in the art from the following description, which includes by way of illustration, one of the best modes contemplated for carrying out the invention. As will be realized, the invention is capable of other different and obvious aspects, all without departing from the invention.

Accordingly, the drawings and descriptions should be regarded as illustrative in nature and not restrictive. It should therefore be understood that the inventor contemplates a variety of embodiments that are not explicitly disclosed herein.

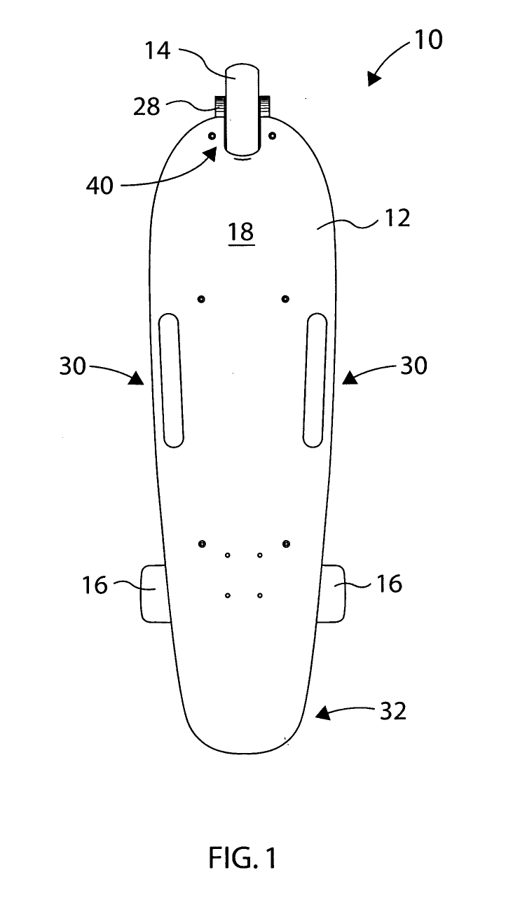

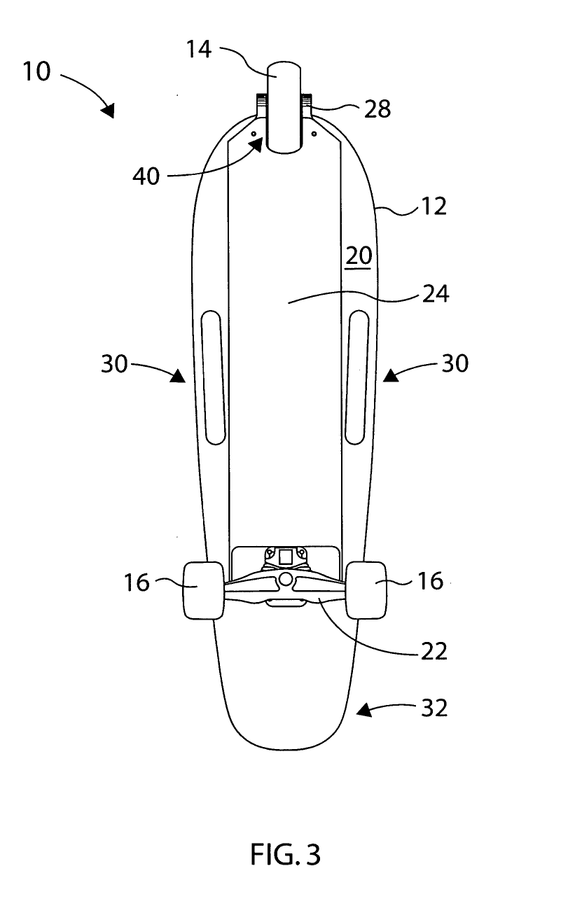

As shown in FIGS. 1-3, the skateboard (10) of the present example comprises a deck (12), a front wheel (14), and a pair of rear wheels (16). The deck (12) comprises a top side (18) and a bottom side (20). Each of the rear wheels (16) is mounted to a truck assembly (22), which is positioned adjacent the bottom side (20) of the deck (12). The skateboard (10) further comprises a pan (24), which is also positioned adjacent the bottom side (20) of the deck (12). The front wheel (14) is positioned on an axle (26), which is substantially held in place by a bracket (28). The bracket (28) is mounted to the bottom side (20) of the deck (12), and is partially enclosed within the pan (24).

The deck (12) of the present example comprises several layers of wood and hardened glue, similar to many conventional skateboard decks. Of course, any other material or materials may be used. For instance, deck (12) may have an inner core of foam and an exterior coated in carbon (e.g., carbon fiber) and epoxy. In another embodiment, deck (12) comprises a combination of layered wood and carbon fiber. In yet another embodiment, deck (12) comprises carbon fiber. It will be appreciated that the use of carbon fiber or similar materials may (or may not) provide weight reduction and enhanced portability, along with other results. Still other suitable material(s) will be apparent to those of ordinary skill in the art.

In the present example, the top side (18) of deck (12) is generally concave. Such concavity may (or may not) provide, among other things, increased rider stability. Of course, this concavity is optional, and any other features may be employed. The present deck (12) further defines a pair of elongate openings (30). These openings (30) may be used as handles for carrying the skateboard (10) or for any other purpose. While openings (30) are shown as being located at the sides of deck (12), it will be appreciated that openings (30) maybe provided in any other location, such as the front and/or back end of the deck (12) by way of example only. It will also be appreciated that the configuration of each opening (30) may be varied in any way. Of course, any alternative to openings (30) may be used, or openings (30) may be eliminated altogether.

The present deck (12) further comprises a tail portion (32). As shown, the tail portion (32) is angled upward relative to the rest of deck (12). Tail portion (32) may be varied in any way, including but not limited to being oriented at any suitable angle relative to the rest of deck (12), or by being omitted. In addition or in the alternative, the front of deck (12) may include a feature similar to tail portion (32) of the present example. It will also be appreciated that the top side (18) of deck (12) may be textured, such as with a textured grip tape by way of example only, or have any other features. Other variations for deck (12) will be apparent to those of ordinary skill in the art.

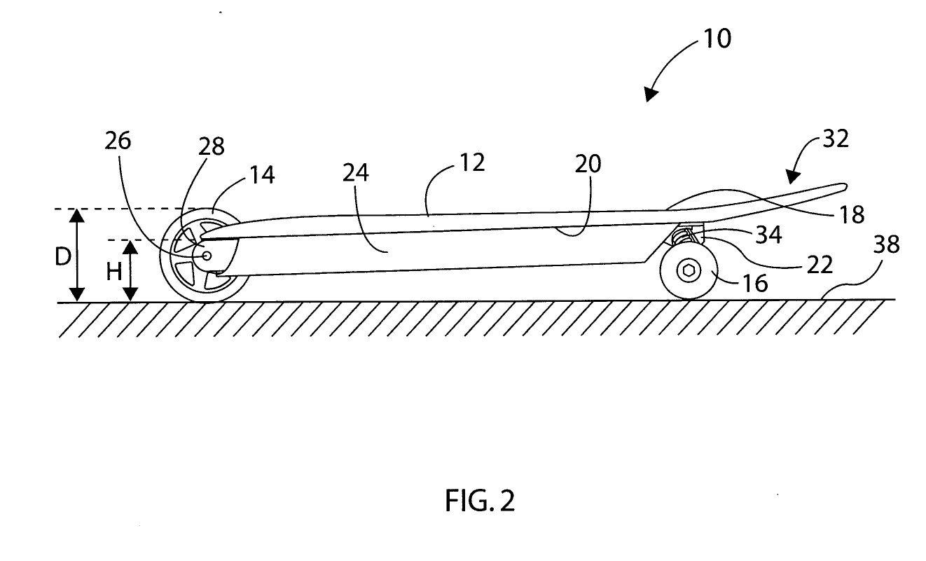

The truck assembly (22) and rear wheels (16) of the present example comprise a conventional skateboard truck assembly (22) and wheels (16). As shown in FIG. 2, the truck assembly (22) has a tension spring (34) positioned proximate to each rear wheel (16), and provides some degree of pivoting relative to deck (12) (e.g., when a rider leans in a direction transverse to deck (12)). In another embodiment, rubber bushings are used to supplement or replace springs (34). Of course, truck assembly (22) and rear wheels (16) may be varied in any suitable way.

As shown in FIG. 2, the front wheel (14) of the present example is larger than the rear wheels (16). In other words, the diameter of the front wheel (14), which is indicated with a “D” in FIG. 2, is greater than the diameter of each rear wheel (16). In addition, the diameter of the front wheel (14) is greater than the height, which is indicated by the “H” in FIG. 2, defined between the bottom side (20) of deck (12) and the ground (38). In order to accommodate this disparity between the diameter of the front wheel (14) and the height of deck (12), a slot (40) is provided in the front end of deck (12) and pan (24). As used herein, the term “wheel” shall be read to include all components of a wheel, including a tire and a corresponding hub. “Wheel” shall also be read to include an axle or similar member that the hub/tire rotates with.

It will be appreciated that a variety of results may (or may not) be obtained by having the disparity between the front wheel (14) diameter and the deck (12) height, including but not limited to increased stability provided by a low center of gravity. In addition, a large front wheel (14) diameter may (or may not) provide increased stability by obtaining a relatively high angular momentum. Other possible effects of having a relatively large front wheel (14) diameter and/or disparity between the front wheel (14) diameter and deck (12) height will be apparent to those of ordinary skill in the art. Other suitable configurations for front wheel (14) will also be apparent to those of ordinary skill in the art.

In another embodiment (not depicted), slot (40) is omitted, and bracket (28) extends further beyond the front edge of deck (12), such that front wheel (14) is positioned beyond the front edge of deck (12). In this embodiment, the extension of bracket (28) and front wheel (14) beyond the front edge of deck (12) accommodates the disparity between the relatively large diameter of front wheel (14) and the height of deck (12) without requiring the formation of slot (40) or another feature in the front edge of deck (12). Other suitable ways in which the relatively large diameter of front wheel (14) may be accommodated will be apparent to those of ordinary skill in the art.

In the present example, front wheel (14) comprises a solid urethane material. The urethane material is molded around a reinforced hub made from aluminum. In another embodiment, the hub of front wheel (14) is made from titanium. In yet another embodiment, the hub is made from hardened plastic. Of course, any other material or materials may be used to construct front wheel (14).

While terms such as “front” and “rear” are used herein to describe front wheel (14) and rear wheels (16), it will be appreciated that these wheels (14 and 16) need not be positioned in such a fashion. In other words, front wheel (14) may in fact be positioned at the rear end of skateboard (10), with rear wheels (16) (and truck assembly (22)) being positioned at the front end of skateboard (10). Of course, suitable adjustments may be made to motors (62) and/or control module (46)(described below) to accommodate such a configuration, if desired. Still other suitable configurations of wheels (14 and/or 16) will be apparent to those of ordinary skill in the art.

Bracket (28) of the present example comprises a generally “U”-shaped aluminum member that is configured to hold axle (26) of front wheel (14). Of course, any material other than aluminum may be used to form bracket (28). It will also be appreciated that bracket (28) need not be unitary, and may instead comprise a plurality of components. For instance, bracket (28) may comprise a pair of separate complimentary members, each being configured to hold a respective end of axle (26). Other variations of bracket (28) will be apparent to those of ordinary skill in the art.

Pan (24) of the present example comprises an aluminum material. Of course, any other material(s) may be used. Pan (24) of this example is secured to bottom side (20) of deck (12). It will be appreciated that flanges or any other features or devices may be used to facilitate the securing of pan (24) to deck (12). Pan (24) may be secured directly to deck (12), may be secured to one or more members that are secured to deck (12), or may be otherwise secured. In another embodiment, pan (24) and bracket (28) are unitary. For instance, pan (24) and bracket (28) may comprise cast or molded metal and/or plastic. Other variations of pan (24) and bracket (28) will be apparent to those of ordinary skill in the art.

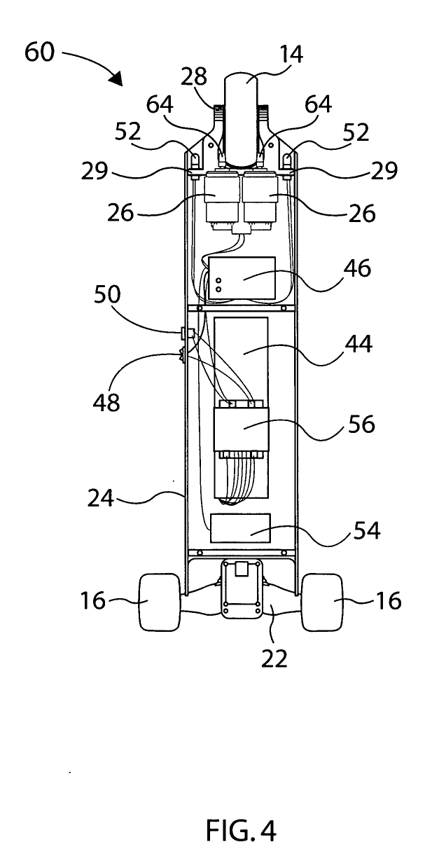

FIG. 4 depicts several components that are housed within or positioned adjacent to pan (24). These components include a battery pack (44), a control module (46), a power switch (48), a recharge port (50), a front wheel drive assembly (60), a receiver (54), and a pair of headlamps (52). While several of these components are shown as being housed with pan (24), it will be appreciated that any or all of the components may be located elsewhere, and may be arranged in any alternative configuration. It will also be appreciated that any variation of, alternative to, or supplement to any of the components may be used, as well as additional components.

Battery pack (44) of the present example comprises a plurality of individual cells (not depicted) and a battery management system (56). In one embodiment, battery pack (44) comprises twenty nickel metal hydride cells shrink wrapped together. In another embodiment, lithium ion polymer cells are used. In yet another embodiment, sealed lead acid batteries are used. Of course, any other type of battery or cell may be used in any number (including just one battery or cell) and in any configuration. It will also be appreciated that skateboard (10) may be configured such that battery pack (44) is modular. In other words, in such a configuration, a variety of types of battery packs (44) may be used for the same skateboard (10). Where battery pack (44) comprises a plurality of batteries, such batteries may be provided in series, in parallel, or in any other configuration. Alternatively, battery pack (44) may be eliminated, and motors (62)(described below) may receive power from any other type of source.

In the present example, battery pack (44) is rechargeable. Such rechargeability is facilitated by recharge port (50). Recharge port (50) is configured to provide recharging of battery pack (44) through use of an adapter (not depicted) that may be plugged into a standard AC outlet. Other ways in which battery pack (44) may be recharged will be apparent to those of ordinary skill in the art. Alternatively, battery pack (44) need not be rechargeable.

Battery pack (44) of the present example further comprises a battery management system (56). Battery management system (56) is configured to manage the charge and/or discharge currents of battery pack (44). For instance, in the event that battery pack (44) is overcharged or overdischarged, the battery management system (56) may break the flow of current. Battery management system (56) may further be configured to protect the battery pack (44) from overheating. Other suitable configurations, features, and variations of battery management system (56) will be apparent to those of ordinary skill in the art. Of course, as with other components described herein, battery management system (56) is merely optional.

Power switch (48) of the present example is a standard switch positioned in series between battery pack (44) and control module (46). Power switch (48) is thus operable to selectively permit or prevent the flow of power between the battery pack (44) and control module (46) in response to mechanical or tactile input from a user. In another embodiment, an automatic power switch is used. In this embodiment, power is turned on when a user manipulates controller (70) (described below), and is turned off after a certain period of time has elapsed since the user last manipulated controller (70). Other suitable variations, substitutes, and supplements of power switch (48) will be apparent to those of ordinary skill in the art.

In one exemplary substitute for power switch (48), a power switch is located only in controller (70)(described below). In this embodiment (not depicted), control module (46)(described below) is configured to receive a signal from controller (70) indicating that this power switch has been activated. Control module (46) may further be configured such that it will refrain from providing power to motors (62) until some indication of a user's presence or use of skateboard (10) is detected after the user has pressed the power button on controller (70). Such an indication of a user's presence or use of skateboard (10) may be provided in a variety of ways. For instance, a weight sensor may be configured to detect the weight of a user on skateboard (10), and to communicate the same to control module (46). Alternatively, a tachometer, proximity sensor or other device may be used to detect motion of skateboard (10) and/or of one of wheels (14 or 16). In yet another variation, an ultra-wideband (UWB) radar is located under deck (12), and is configured to detect the presence of a user's foot on deck (12). Still other ways in which a user's presence or use of skateboard (10) may be detected and/or communicated to control module (46) will be apparent to those of ordinary skill in the art. In addition, in this embodiment, user activity may be monitored (e.g., by the same sensor(s) that detected the user's presence or use of skateboard (10)) such that it may be determined when a user has become inactive with skateboard (10). When user inactivity is so detected, a timer may begin running, such that skateboard (10) automatically turns off after certain period of time has elapsed since the user used skateboard (10).

Control module (46) of the present example comprises a circuit board configured to direct DC current to and from battery pack (44), controller (70)(described below), motors (62)(described below), power switch (48), and recharge port (50). Control module (46) may also include a safety switch configured to shut skateboard (10) off if any portion of control module (46) is overloaded with DC current. Other suitable configurations for, components of, features of, and alternatives to control module (46) will be apparent to those of ordinary skill in the art.

Receiver (54) of the present example is configured to wirelessly receive control signals from a controller, various examples of which are described below. As shown, receiver (54) is in communication with control module (46) to effect user control of drive assembly (60). Suitable configurations and variations of receiver (54) will be apparent to those of ordinary skill in the art. To the extent that interference between other components of skateboard (10) and receiver (54) adversely affects the operability of receiver (54), such affects may be addressed in a variety of ways, including but not limited to shielding (e.g., by shielding the interfering component) or positioning (e.g., of receiver (54) and/or the interfering component). In an alternate embodiment, receiver (54) is positioned behind truck assembly (22). In another alternative embodiment, receiver (54) is attached to or integral with control module (46). Of course, any other variation of receiver (54), including but not limited to substitutes, supplements, alternative configurations, and alternative positioning, may be used.

As shown in FIG. 4, a pair of headlamps (52) are positioned at the front of pan (24), and are secured to flanges (29) extending outwardly from each side of bracket (28). Headlamps (52) may comprise incandescent bulbs, light emitting diodes (LEDs) of any type, or any other source of light. Headlamps (52) are in electrical communication with control module (46), which may selectively provide electrical signals to headlamps (52) to effect illumination of headlamps (52). As will be described in greater detail below, selective illumination of headlamps (52) may be subject to user control as provided through controller (70). It will also be appreciated that headlamps (52), pan (24), and/or other components may be configured (e.g., by recessing headlamps(52) within pan (24)) such that headlamps (52) are protected from damage. Of course, headlamps (52) are optional, and may be varied, supplemented, substituted, or controlled in any suitable way.

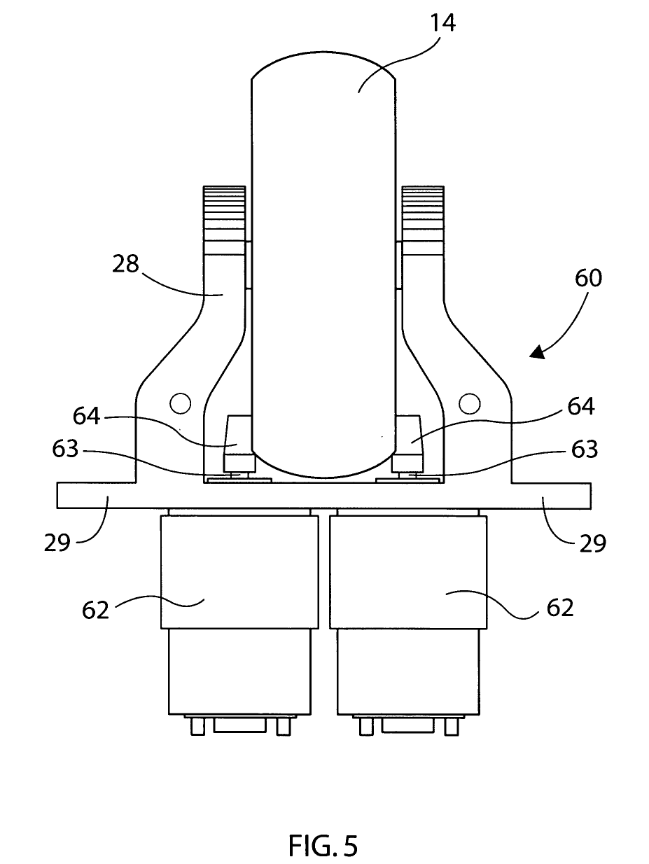

The front wheel drive assembly (60) shown in FIGS. 4 and 5 comprises a pair of motors (62). Motors (62) of the present example are conventional DC brush motors, though any other type of motor may be used. In addition, as used herein, the term “motor” shall be read to include fuel-based engines and the like. The motors (62) of the present example are responsive to voltages from about 12 volts to about 36 volts. Alternatively, any other voltages may be used. Motors (62) of the present example are operable to rotate in excess of approximately 12,000 rpm. Of course, any other rotational speed may be used, including rpm's below 12,000. In addition, motors that are not operable to rotate in excess of approximately 12,000 rpm may be used.

Each motor (62) of the present example is operable to rotate a respective shaft (63). A cone (64) is secured to the end of each shaft (63). In one embodiment, motors (62) are mounted to bracket (28). In another embodiment, motors (62) are mounted to deck (12). In yet another embodiment, motors (62) are mounted to both bracket (28) and deck (12). Of course, motors (62) may be mounted elsewhere.

The relative configuration of front wheel (14) and cones (64) is such that front wheel (14) fits tightly between cones (64). Each cone (64) is thus positioned to engage with a respective side of front wheel (14). Such engagement may effect torque transfer from cones (64) to front wheel (14), and may be provided by friction, corresponding teeth and grooves, or using any suitable structure or technique.

Where friction is used to effect torque transfer, it will be appreciated that such friction may be facilitated through certain surface characteristics of cones (64) and/or front wheel (14). For instance, cones (64) and/or front wheel (14) may comprise a rubber material. In another embodiment, cones (64) comprise a metal material, while front wheel (14) comprises a polyurethane material. In yet another embodiment, cones (64) are generally smooth. In still another embodiment, cones (64) comprise a generally abrasive or grit-like surface. Other suitable materials and surface features for cones (64) and front wheel (14) will be apparent to those of ordinary skill in the art. In addition, it will be appreciated that torque transfer for driving front wheel (14) may be provided or facilitated in a variety of alternative ways, several of which will be described below.

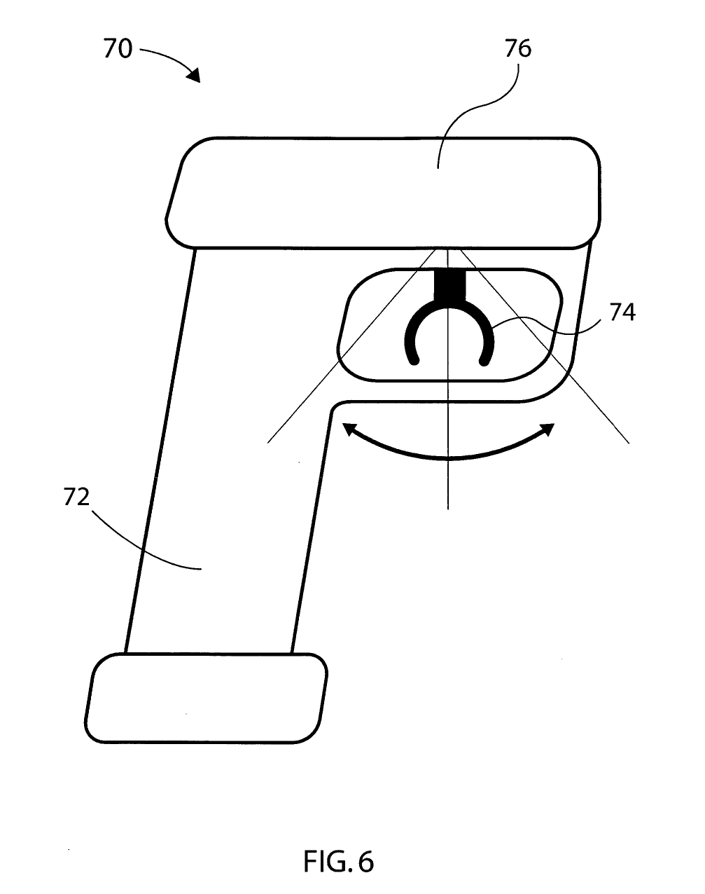

FIG. 6 shows an exemplary controller (70). Controller (70) comprises a handle (72) and a trigger (74) extending downwardly from a top portion (76). Handle (72) is configured to be gripped by the hand of a user, while trigger (74) is configured to be engaged by a finger of a user. Controller (70) further comprises a circuit board (not depicted) housed within handle (72). In the present example, the circuit board of controller (70) is in wireless communication with control module (46). Suitable transmitter/receiver configurations for providing such wireless communication, as well as various suitable wireless communication methods and protocols, will be apparent to those of ordinary skill in the art. It will also be appreciated that controller (70) may comprise one or more batteries or similar devices (e.g., to power a transmitter/receiver).

In one embodiment, trigger (74) comprises a “wig wag” throttle. It will be appreciated by those of ordinary skill in the art that “wig wag” is a typical term used for a common variable speed reversing control. For instance, some overhead cranes and winches are controlled by a “wig wag” control. Of course, trigger (74) may take a variety of alternative forms.

The circuit board is in further communication with trigger (74), such that movement of trigger (74) will effect transmission of an acceleration signal and/or a deceleration signal to control module (46). Trigger (74) is thus operable to provide control of motors (62). In one embodiment, trigger (74) is operable to communicate a variable acceleration signal to control module (46) in response to mechanical user input. For instance, trigger (74) may be configured such that a user may pull the trigger to effect acceleration of skateboard (10). The rate of acceleration may be dependent on the position of trigger (74) and/or the rate at which the position of trigger (74) is changed. In this example, because the position of trigger (74) may be variably controlled by the user, the user may accelerate skateboard (10) in a variable and controlled fashion. Alternatively, trigger (74) may be configured such that acceleration is effected by pushing trigger (74). Still other variations will be apparent to those of ordinary skill in the art. Several of such variations will be described in greater detail below.

Where pulling of trigger (74) effects acceleration of skateboard (10), pushing of trigger (74) may effect deceleration of skateboard (10). Similarly, where pushing of trigger (74) effects acceleration of skateboard (10), pulling of trigger (74) may effect deceleration of skateboard (10). Various ways in which deceleration or braking of skateboard (10) may be provided will be described in further detail below. In addition, controller (70) may be operable to permit skateboard (10) to coast. For instance, controller (70) may be configured such that skateboard (10) will coast when trigger (74) is centered. Controller (70) may further be configured such that trigger (74) is biased to be centered by one or more springs, resilient members, or any other means. Of course, the acceleration, deceleration/braking, and coasting examples discussed herein are non-exhaustive, and any other alternatives or variations may be used.

In one embodiment, braking of skateboard (10) is provided through motor braking. For instance, such braking may be variable and controllable by the user. Such variability and controllability may be provided through a trigger (74), knob, slider, or any other means for receiving such variable user input. Alternatively, motor braking may be provided without such braking being variable by the user. For instance, a braking button may be provided that is operable to communicate a simple braking signal to control module (46). Such a signal may “simple” in the sense that it is simply on or off; rather than being somewhere along a range of several possible values. In such an embodiment, in response to receiving a simple braking signal, the control module (46) may communicate a ramping braking signal to motors (62). This ramping braking signal may effect increasing braking through the motors (62). Suitable ways in which a ramping braking signal may effect increasing braking through the motors (62) will be apparent to those of ordinary skill in the art, including but not limited to shunting. In one embodiment, the amount of braking is dependent on speed. Alternatively, the amount of braking may be dependent on a variety of other factors. It will also be appreciated that the rate of change of such braking may be linear, non-linear, constant, varying, dependent on factors such as time or speed, etc., or may be independent of factors such as time or speed. Of course, a braking signal having any other properties may be used.

In one embodiment, a ramping braking signal plateaus at a certain point (e.g., after a certain period of time has elapsed, after a certain speed has been reached, etc.), such that the braking signal either ceases altogether or no longer changes. In other words, while the motors (62) provide increasing braking while the ramping braking signal is still ramping, the motors (62) will provide constant braking or no braking at all when the ramping braking signal reaches its plateau in the present example. Suitable features of such a plateau in a braking signal, including but not limited to how such a plateau is obtained and the consequences of reaching the plateau, will be apparent to those of ordinary skill in the art.

In one embodiment, acceleration and deceleration of skateboard is provided by acceleration and deceleration of motors (62). In another embodiment, motors (62) are configured to run at a generally constant speed, such that acceleration and/or deceleration is provided through changing gears or using any other techniques. Of course, combinations of acceleration/deceleration of motors (62) and gear-changing, etc., may be used. Still other ways for effecting acceleration and/or deceleration of skateboard (10) may be used.

While several examples are described herein as using motor braking, it will be appreciated that any other type of braking may be used, including but not limited to mechanical, frictional, hydraulic, magnetic, electromagnetic, or any other type of braking. Such braking may be used in addition to or as an alternative to motor braking. In one embodiment, a mechanical braking system comprising a cable and brake pads are provided. The brake pads are positioned adjacent a wheel (14 or 16), and the cable is operable to cause the pads to engage with the wheel (14 or 16). In another embodiment, disc brakes are used. Other braking variations will be apparent to those of ordinary skill in the art. Of course, as a further alternative, braking may be omitted altogether.

In another embodiment (not shown in FIG. 6), controller (70) includes a reset button. The reset button is operable to, upon actuation by the user, turn skateboard (10) off then on again to reset at least a portion of the circuits in control module (46). Alternatively, such resetting of control module (46) may be provided in any other way, or may be omitted.

In yet another embodiment (not shown in FIG. 6), controller (70) includes a button or other device for selectively activating the headlamps (52). Suitable devices and mechanisms for selective activation of headlamps (52) through controller (70) will be apparent to those of ordinary skill in the art.

In still another embodiment (not shown in FIG. 6), controller (70) includes one or more visual displays indicating performance characteristics, use characteristics, or other characteristics of skateboard (10). By way of example only, controller (70) may include a series of LEDs indicating the voltage level of battery pack (44) and/or motors (26). Alternatively, a liquid crystal display (LCD) screen may be used to provide such visual indication and/or visual indication of other skateboard (10) characteristics. Other forms of visual display will be apparent to those of ordinary skill in the art. A visual display may also provide a visual indication of speed and/or distance traveled. Such information may be gathered by tracking performance of motors (26) (e.g., with a tachometer, light sensors, proximity sensors, etc.), control module (46), and/or performance of another component of skateboard (10). Alternatively, controller (70) or skateboard (10) may comprise a global positioning system (GPS), such that the GPS is operable to provide speed, distance traveled, or other position-related information. Of course, any other type of information may be displayed or otherwise provided (e.g., audibly, etc.) to the user in any suitable fashion. In addition, it will be appreciated that the variations of controller (70) described herein may also be applied to any of the other alternate controllers described herein.

Controller (70) may further comprise a strap (not depicted) or similar device for securing controller (70) in a user's hand. In such embodiments, controller (70) may thus be held the user's hand without the need for the user to grip controller (70).

It will be appreciated that controller (70) may be varied in any other suitable way, as may methods for controlling motors (62). Several of such variations will be described below, while others will be apparent to those of ordinary skill in the art.

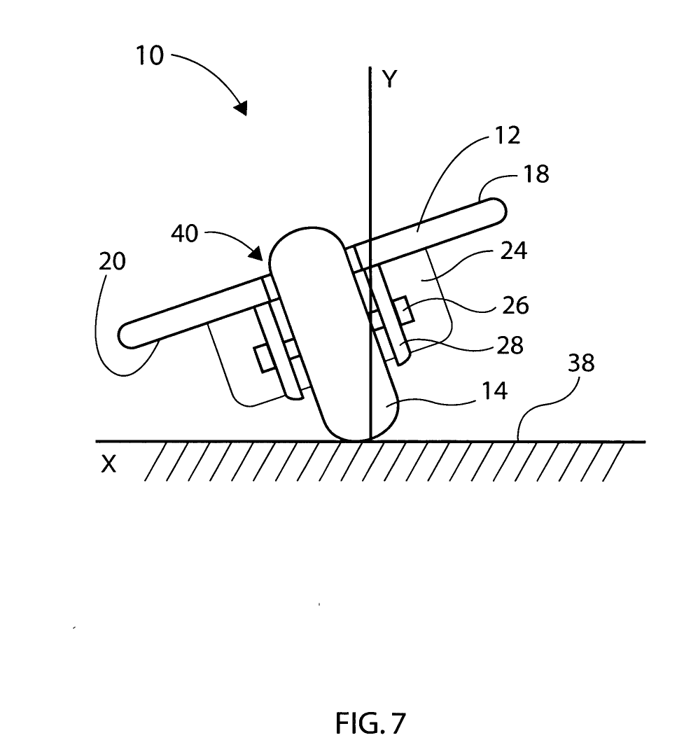

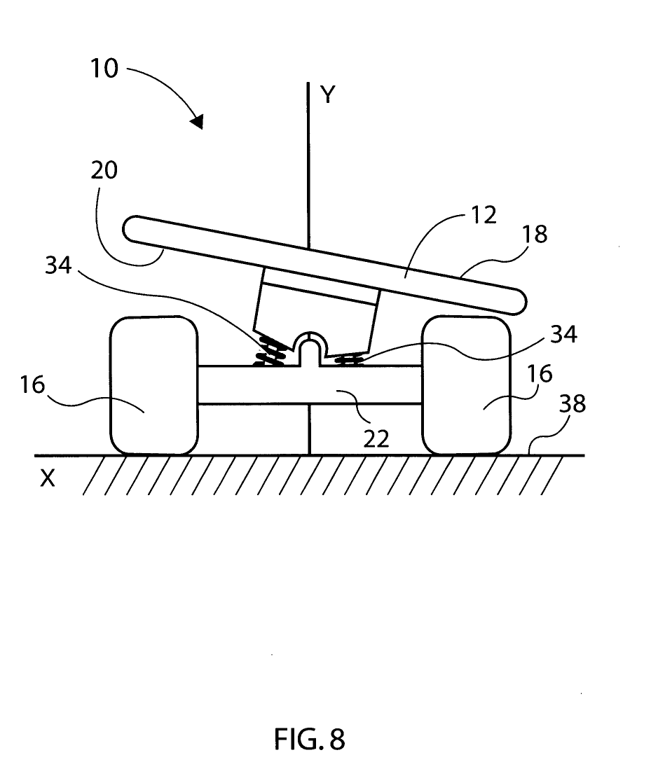

FIGS. 7 and 8 show deck (12) being tilted relative to ground (38), as may be encountered by a user steering the skateboard (10) by leaning. As shown, truck assembly (22) provides pivoting of rear wheels (16) relative to deck (12) during such tilting; whereas the position of front wheel (14) relative to deck (12) remains substantially fixed during the tilting. It will be appreciated that, with deck (12) and front wheel (14) tilting unitarily during steering of skateboard (10), drive assembly (60) of this example will also tilt unitarily with these components. Thus, the engagement of drive assembly (60) and front wheel (14) of the present example will permit steering and will remain unaffected by steering of skateboard (10). While the orientation of front wheel (14) relative to ground (38) changes during the tilting encountered while steering skateboard (10), front wheel (14) of the present example is configured to maintain constant surface contact with ground (38). Such constant surface contact may be provided by the rounded profile of front wheel (14).

It will be appreciated that the configuration depicted in FIGS. 7 and 8 may (or may not) provide more responsive steering than that provided by conventional four-wheeled skateboards. The depicted configuration may also (or may not) provide less drag against propulsion of skateboard (10) compared to conventional four-wheeled skateboards. The depicted configuration may thus (or may not) provide higher efficiency of motors (62) and/or batteries (44) compared to a conventional four-wheeled skateboard using the same drive assembly (60).

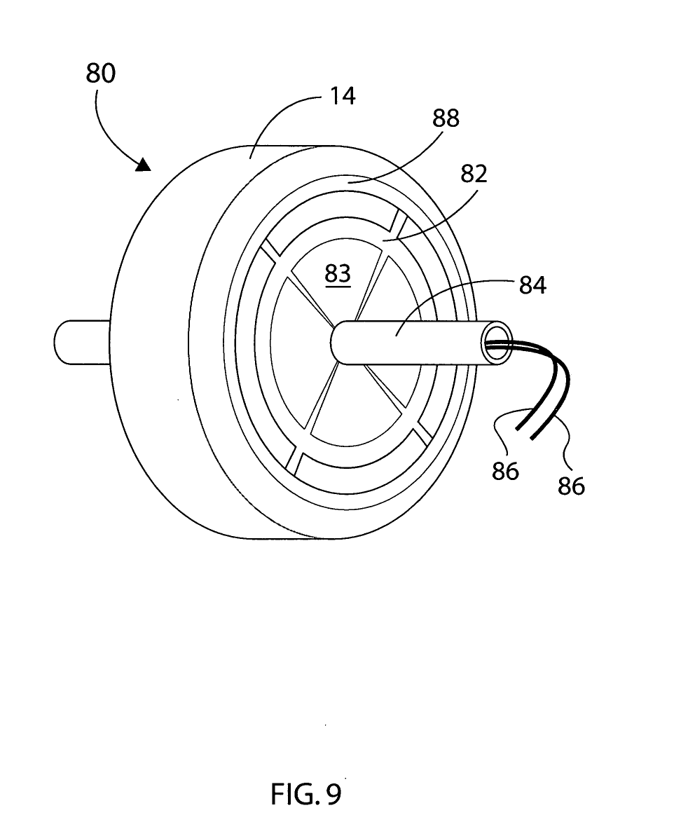

An exemplary alternative front wheel drive assembly (80) is shown in FIG. 9. The alternative front wheel drive assembly (80) comprises a hub motor (82), which is positioned within front wheel (14) such that the axis of hub motor (82) is aligned with the axis of front wheel (14). In one embodiment, front wheel (14) is molded around hub motor (82). In another embodiment, front wheel (14) is positioned around hub motor (82) with an interference fit. Other configurations may be used. A static axle (84) provides an axis about which the front wheel (14) may rotate. Static axle (84) of this example is “static” in the sense that it does not rotate with front wheel (14), but instead remains substantially motionless relative to bracket (28) during rotation of front wheel (14). Front wheel (14) has a hub wheel casing (88) positioned adjacent the inner diameter of front wheel (14). A plurality of magnets (not depicted) are fixedly secured to the inner diameter of hub wheel casing (88). Alternatively, a plurality of generally disc-shaped magnets could be positioned perpendicular to static axle (84). In the present example, an outer casing (83) encloses inner portions of hub motor (82). Outer casing (83) is configured to prevent debris and moisture from entering hub motor (82). Outer casing (83) is supported by heavy load bearings, which ride on static axle (84), thereby permitting outer casing (83) and front wheel (14) to rotate about static axle (14).

Static axle (84) is hollow, and houses wires (86) that communicate power and control signals to hub motor (82). In particular, wires (86) communicate current from control module (46) to armature brushes (not depicted) housed within hub motor (82). This current may (or may not) create electromagnetic force opposing the magnetic forces provided by the magnets secured to the hub wheel casing (88), thereby forcing the magnets secured to the hub wheel casing (88) to move in a circular path around static axle (84). Alternatively, hub motor (82) may function in a variety of alternative ways. Hub motor (82) may comprise any material or materials, including but not limited to aluminum, titanium, and/or hardened plastic. Suitable variations of hub motor (82), including but not limited to a brushless hub motor, will be apparent to those of ordinary skill in the art.

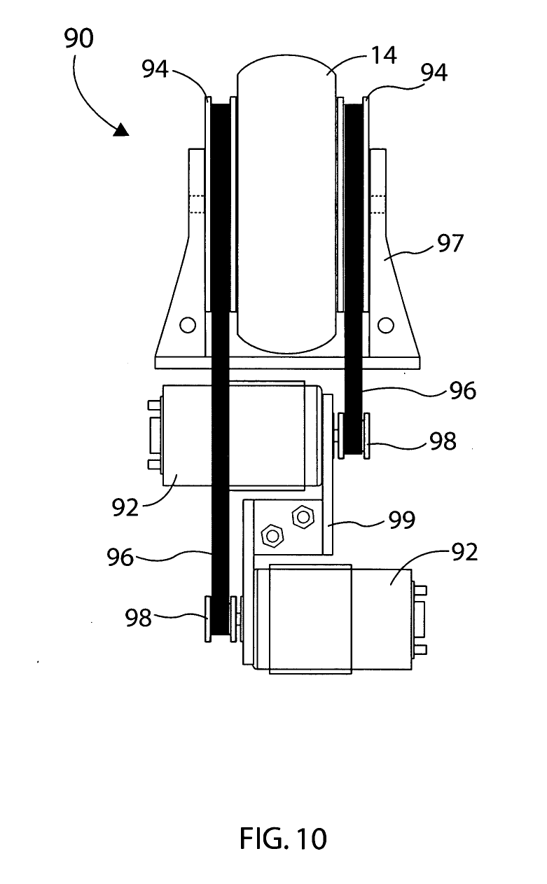

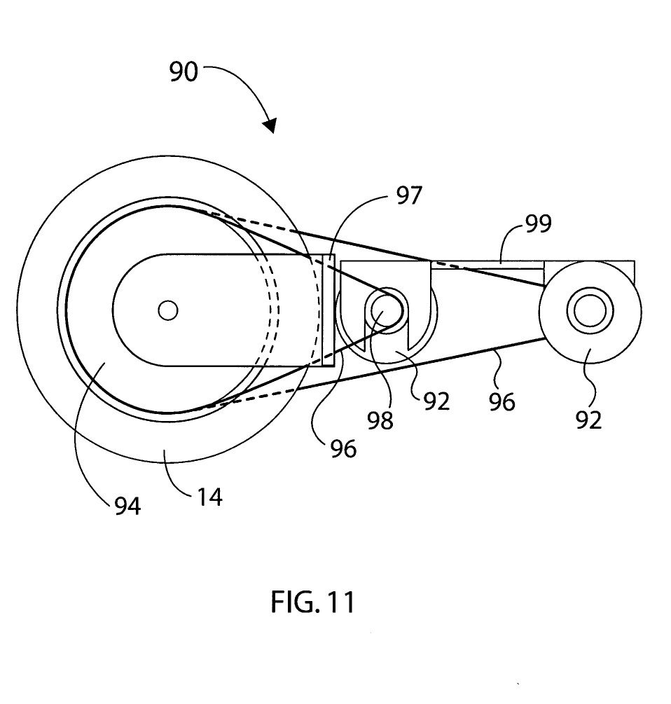

FIGS. 10 and 11 show another alternative front wheel drive assembly (90). In this embodiment, a pair of motors (92) are secured to a bracket (99). Motors (92) are oriented in opposite directions relative one another. While motors (92) are shown as being staggered along the longitudinal dimension of deck (12), it will be appreciated that motors (92) may be coaxially aligned, with the axis of each motor (92) being oriented transverse relative to deck (12). Of course, any other relative positioning and orientations of motors (92) may be used. In the present example, bracket (99) is secured to deck (12). Each motor (92) has a drive wheel (98). Each drive wheel (98) is driven by its respective motor (92).

In this example, each side of front wheel (14) has a pulley wheel (94) secured thereto. Pulley wheels (94) are positioned within bracket (97), which also holds front wheel (14) in place. Drive assembly (90) further comprises a set of belts (96). Each belt (96) is in mechanical communication with a drive wheel (98) and a corresponding pulley wheel (94), such that belts (96) are operable to drive front wheel (14) via torque transfer. It will be appreciated that any type of belts (96) may be used, including but not limited to toothed and non-toothed belts. Of course, any suitable alternative to belts (96) may be used, including but not limited to chains, sprockets, gears, and the like. It will also be appreciated that front wheel drive assembly (90) may be configured such that one or more of belts (96) is/are positioned outside of bracket (97). Still other variations will be apparent to those of ordinary skill in the art.

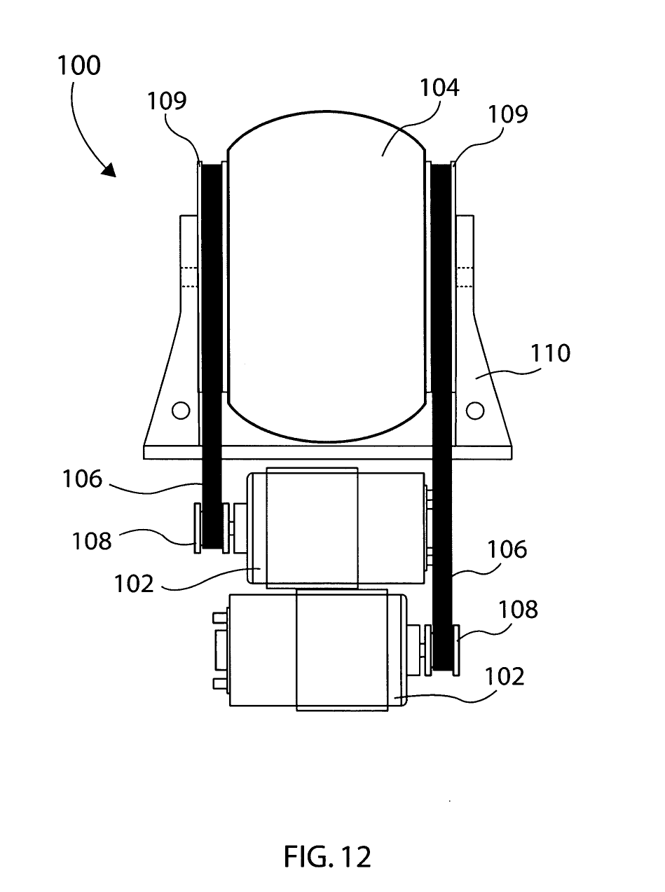

FIG. 12, shows yet another alternative front wheel drive assembly (100). In this embodiment, a pair of motors (102) are used to drive a front wheel (104). Front wheel (104) of this example is wider than front wheel (14) of other examples described herein. Motors (102) are oriented in opposite directions relative one another. While motors (102) are shown as being staggered along the longitudinal dimension of deck (12), it will be appreciated that motors (102) may be coaxially aligned, with the axis of each motor (102) being oriented transverse relative to deck (12). Of course, any other relative positioning and orientations of motors (102) may be used. Each motor (102) in the present example has a drive wheel (108). Each drive wheel (108) is driven by its respective motor (102).

In this example, each side of front wheel (104) has a pulley wheel (109) secured thereto. Pulley wheels (109) are positioned within bracket (110), which also holds front wheel (104) in place. Drive assembly (100) further comprises a set of belts (106). Each belt (106) is in mechanical communication with a drive wheel (108) and a corresponding pulley wheel (109), such that belts (106) are operable to drive front wheel (104) via torque transfer. It will be appreciated that any type of belts (106) may be used, including but not limited to toothed and non-toothed belts. Of course, any suitable alternative to belts (106) may be used, including but not limited to chains, sprockets, gears, and the like. It will also be appreciated that front wheel drive assembly (100) may be configured such that one or more of belts (106) is/are positioned outside of bracket (110). Still other variations will be apparent to those of ordinary skill in the art.

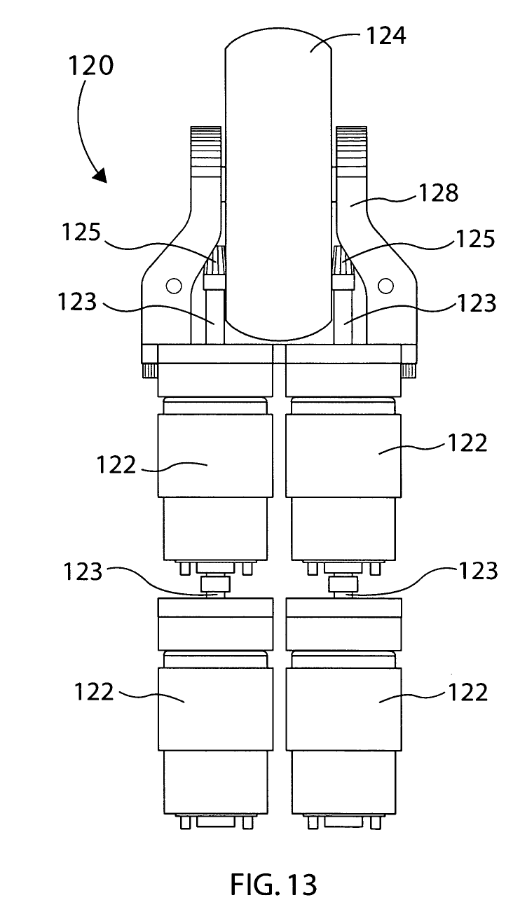

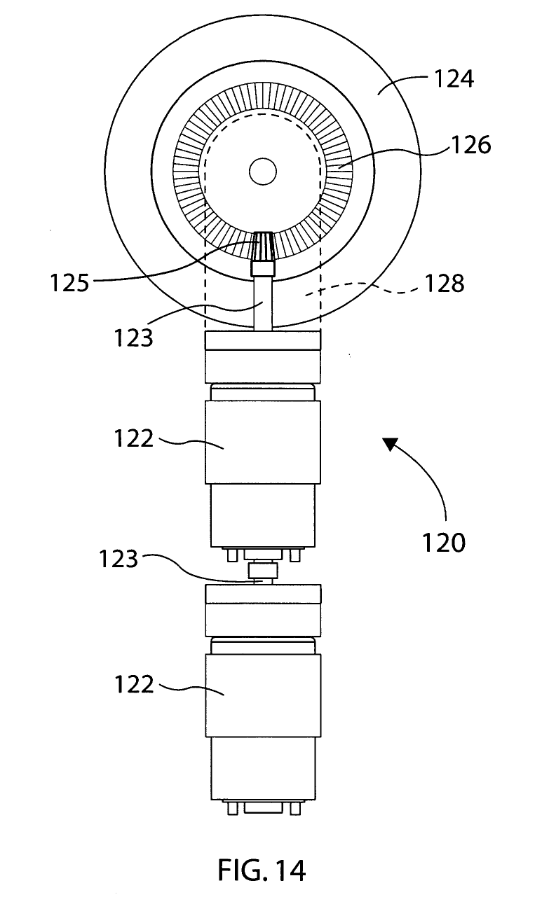

FIGS. 13 and 14 show still another alternative front wheel drive assembly (120). In this embodiment, four motors (122) are used to drive a front wheel (124). Front wheel (124) is held in place by a bracket (128). Each side of front wheel (124) has a geared portion (126). Geared portion (126) may comprise a plurality of recesses and/or a plurality of teeth. As shown, the four motors (122) comprise two pairs of motors (122), with each motor (122) of a pair being coaxially aligned. In this example, each motor (122) of a pair drives a common shaft (123). Of course, each motor (122) of a pair need not drive a common shaft (123). In another embodiment, each motor (122) has its own discrete shaft (123), and the shafts (123) of a motor (122) pair are coupled together by a coupler. Such a coupler may be rigid, flexible, or have any other suitable properties. Other techniques for effecting cooperation between motors (122) of a pair will be apparent to those of ordinary skill in the art.

Each of the common shafts (123) in the present example has a geared cone (125) positioned at its end. Each geared cone (125) is configured to mesh with corresponding geared portion (126) of front wheel (124), such that each geared cone (123) may transfer torque to front wheel (124). Thus, in this example, geared cone (123) and geared portion (126) provide a bevel geared engagement. Of course, any other type of geared engagement may be used, several examples of which will be apparent to those of ordinary skill in the art. As used herein, the phrase “geared engagement with the front wheel” and its variants shall be read to include embodiments where a driving member (e.g., geared cone, chain, gear, etc.) is in geared engagement with a wheel itself, as well as embodiments where a driving member is in geared engagement with a member that is secured to, integral with, or otherwise in communication with a wheel. A subset of this type of geared relationship would include one in which a driving member is in “geared engagement directly with the front wheel.” As used herein, the phrase “geared engagement directly with the front wheel” and its variants shall be read to include embodiments where the driving member is in geared engagement directly with a wheel itself or an integral component of a wheel.

It will also be appreciated that in this embodiment, as well as various other embodiments, multiple variations of differential torque conversion may be used. In one exemplary variation, geared portion (126) of front wheel (124) is positioned closer to the center of front wheel (124) than as shown. In this variation, shaft (123) and/or geared cone (125) is extended accordingly. It will be appreciated that this variation may decrease the gearing ratio. In a further variation, a planetary gearbox (not depicted) or similar mechanism is positioned between each motor (123) and corresponding geared cone (125) to compensate in gear reduction lost at front wheel (124). It will be appreciated that, in this embodiment (among others), geared cones (125) and geared portions (126) of front wheel (124) may be enclosed. Such enclosure may facilitate the prevention of dust and debris from entering the interface between geared cones (125) and geared portions (126) of front wheel (124). Still other variations of a drive assembly using geared or other torque transfer will be apparent to those of ordinary skill in the art.

While several front wheel drive assemblies have been described herein, it will be appreciated that each of the exemplary front wheel drive assemblies may be further modified in various ways. For instance, while the examples discussed above include two or four motors, any other number of motors may be used, including but not limited to one or six. The axis of any motor(s) used to drive skateboard (10) may have any suitable orientation, including but not limited to longitudinal or transverse relative to deck (12). In addition, where more than one motor is used, such motors may be in any suitable relative alignment, including but not limited to coaxial, parallel, or perpendicular. Skateboard (10) may also use one or more alternative sources other than one or more motors for driving skateboard (10). Suitable motor alternatives will be apparent to those of ordinary skill in the art.

In addition, other suitable front wheel drive assemblies will be apparent to those of ordinary skill in the art. It will also be appreciated that skateboard (10) may additionally or alternatively be rear wheel driven. For instance, any of the front wheel drive assemblies described herein, or variations thereof, may be applied to one or both of rear wheels (16). Where front and rear wheels (14 and 16) are driven, wheels (14 and 16) may be driven by the same drive assembly or separate drive assemblies. Still other variations for driving one or more wheels (14 and/or 16) will be apparent to those of ordinary skill in the art.

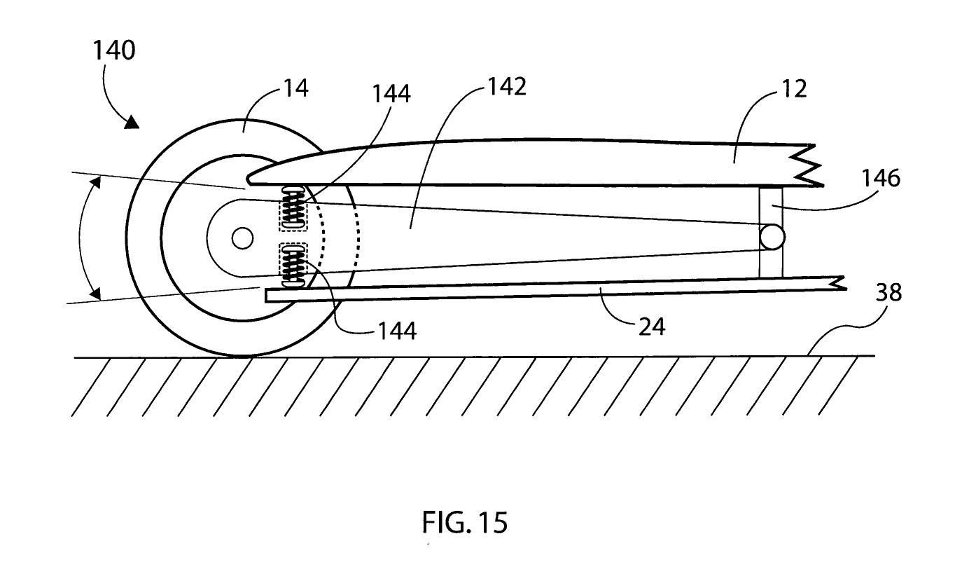

In one embodiment, skateboard (10) is provided with front wheel suspension. An exemplary embodiment in which such front wheel suspension is provided is shown in FIG. 15. In this example, suspension system (140) comprises arms (142), resilient members (144), and anchor member (146). It will be appreciated that suspension system (140) may be substantially enclosed within pan (24), or may be fully or partially exposed. In the present example, the distal end of each arm (142) is positioned adjacent each side of front wheel (14), and front wheel (14) is mounted thereto. Anchor member (146) is secured to deck (12) and pan (24). The proximal end of each arm (142) is pivotally secured to anchor member (146), such that each arm (142) is permitted to rotate relative to anchor member (146). A resilient member (144) is secured to each arm (142) and deck (12). Another resilient member (144) is secured to each arm (142) and pan (24). Resilient members (144) are configured to resist yet permit pivoting of arms (142) about anchor member (146). While resilient members (144) of the present example are shown as comprising springs, it will be appreciated that any other resilient member may be used, including but not limited to sheet rubber. In another embodiment, resilient members (144) comprise springs on the top side of each arm (142) and padded rubber on the bottom side of each arm (142). Still other forms and variations of resilient members (144) will be apparent to those of ordinary skill in the art, as well as alternatives to resilient members (144). It will be appreciated that this embodiment and variations thereof may provide shock absorption, vibration reduction, and/or other results.

Suspension system (140) shown in FIG. 15, and variations thereof, may be used with any type of drive system or assembly. In one embodiment, suspension system (140) is used with a skateboard (10) having a hub motor (e.g., such as hub motor (82) shown in FIG. 9). It will be appreciated that, where certain types of drive systems or assemblies are used, it may be desirable to secure at least a portion of such drive systems or assemblies to one or more of arms (142), such that the drive system or assembly may move with front wheel (14) during shock absorption. Alternatively, a drive system or assembly and suspension system (140) may be independent relative one another. Still other relative configurations for suspension system (140) and drive systems or assemblies will be apparent to those of ordinary skill in the art.

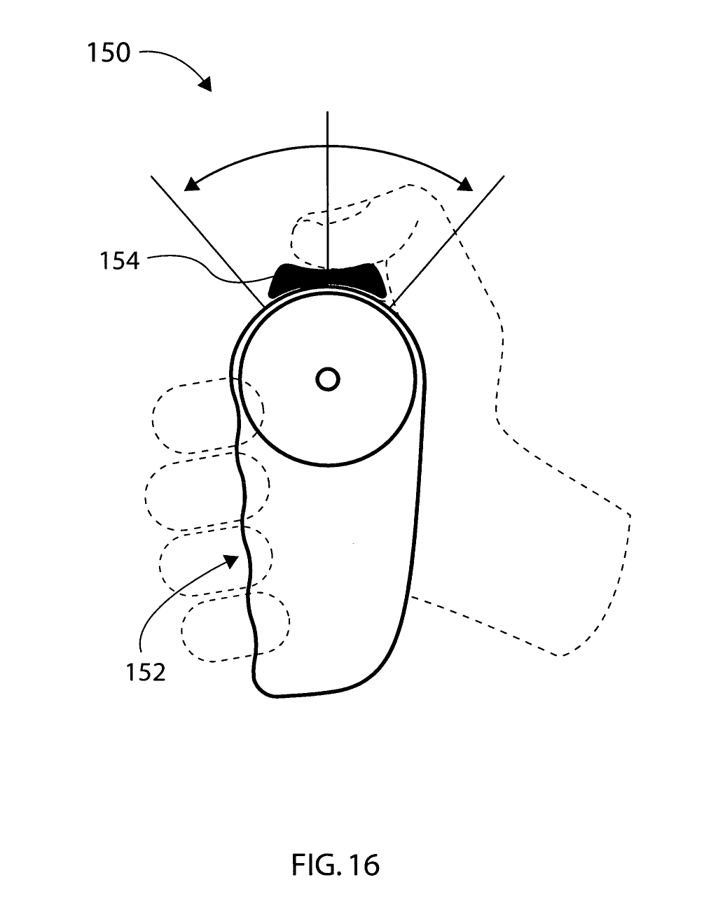

FIG. 16 shows an alternative controller (150). Controller (150) of this example comprises a grip portion (152) and a slider (154). Grip portion (152) is configured to be gripped by a user's hand, while slider (154) is configured to be manipulated by the user's thumb. The slider (154) of this example operates in a manner similar to the trigger (74) shown in FIG. 6. That is, pushing of slider (154) may effects acceleration of skateboard (10), while pulling of slider (154) may effect deceleration of skateboard (10) (or vice-versa). Similarly, skateboard (10) may be configured to coast when slider (154) is centered. All other features and variations described above with respect to controller (70) may also be applied to controller (150). Still other variations will be apparent to those of ordinary skill in the art.

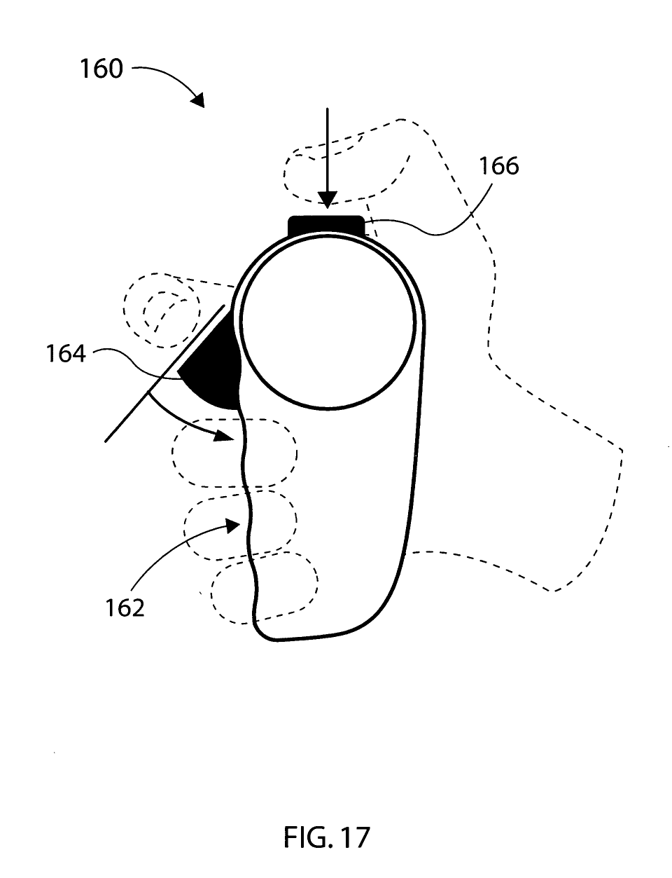

Yet another example of a controller (160) is shown in FIG. 17. In this embodiment, controller (160) comprises a grip portion (162), a trigger (164), and a button (166). Grip portion (162) is configured to be gripped by a user's hand; trigger (164) is configured to be manipulated by the user's finger; and button (166) is configured to be manipulated by the user's thumb. In the present example, button (166) is configured such that it provides braking of skateboard (10) as described above with respect to controller (70). In another embodiment, button (166) is configured as a reset button as described above with respect to controller (70). In addition, trigger (164) is configured such that it effects acceleration of skateboard (10) in a manner similar to trigger (74) of controller (70). Trigger (164) may be biased outward with a resilient member (e.g., a spring) or other means. Where neither button (166) nor trigger (164) is being manipulated by the user, skateboard (10) may be configured to coast. It will be appreciated that all other features and variations described above with respect to controller (70) may also be applied to controller (160). Still other variations will be apparent to those of ordinary skill in the art.

While several controllers have been described herein, it will be appreciated that each of the exemplary controllers may be further modified in various ways. By way of example only, any controller may be in wireless communication with a control module (46) using any techniques, including but not limited to radio frequency (RF) communication, ultra-wideband (UWB) communication, or any other form of communication. Other types of wireless communication, including ways in which such communication between a controller and a control module may be provided, will be apparent to those of ordinary skill in the art. With respect to user input into a controller, any suitable alternative to triggers, sliders, and buttons may be used, including but not limited to switches (e.g., mechanical or thin film switches), knobs, dials, or any other means for receiving tactile user input. In addition, while the exemplary controllers discussed herein are configured to receive tactile user input, it will be appreciated that a controller may be configured to receive any other form of user input. By way of example only, a controller may be configured to receive voice input from a user.

Where wireless communication is used to effect user control of skateboard (10), hardware and/or software involved in such communication may be configured (or configurable) such that a certain controller is associated with a certain skateboard (or a certain limited number of skateboards). By way of example only, the transmission signal protocol may be varied to reduce signal interference or crossover among controllers relative to other controllers or skateboards. In this embodiment, the likelihood of one user's controller being operable to control another user's skateboard may (or may not) be reduced, if not eliminated. Such an embodiment, may (or may not) permit users to ride in groups without concern over each other's controllers interfering with each other's skateboards. Of course, other results may be provided by such an embodiment.

It will also be appreciated that any controller may be connected to a control module (46) or other component via one or more wires to provide communication. In one embodiment (not depicted), a controller is connected to a control module via a cord. The cord may be approximately 3-4 feet in length, or any other length. The cord may further have a variable length. The cord of the present example houses one or more wires for communication of signals between the controller and the control module. The cord may also comprise one or more metal cables or similar means for strengthening the cord and/or reinforcing connections between the wires and control module (46). Where a corded controller is used, it will further be appreciated that a cable or other device for communicating mechanical braking or other braking may be included in the cord. For instance, a standard bicycle hinged handbrake lever or finger lever may be added to a controller to actuate a mechanical friction brake or other type of brake.

Still other suitable controllers and variations will be apparent to those of ordinary skill in the art.

Having shown and described various embodiments and concepts of the invention, further adaptations of the methods and systems described herein can be accomplished by appropriate modifications by one of ordinary skill in the art without departing from the scope of the invention. Several of such potential alternatives, modifications, and variations have been mentioned, and others will be apparent to those skilled in the art in light of the foregoing teachings. Accordingly, the invention is intended to embrace all such alternatives, modifications and variations as may fall within the spirit and scope of the appended claims and is understood not to be limited to the details of structure and operation shown and described in the specification and drawings.

What is claimed is:

1. A skateboard, comprising:
(a) a deck having a front end, a back end, a top side, and a bottom side;
(b) a pair of wheels secured to a truck assembly, wherein the truck assembly is secured to the deck;
(c) a front wheel having a front wheel diameter; and
(d) a deck height defined by the distance between the bottom side of the deck and the ground when the pair of wheels and the front wheel are in contact with the ground;
wherein the front wheel diameter is greater than the deck height.

2. The skateboard of claim 1, further comprising one or more motors, wherein the one or more motors are operable to drive one or more of the pair of wheels or the front wheel.

3. The skateboard of claim 2, wherein at least one of the one or more motors comprises a cone member, wherein the cone member is engaged with the front wheel of the skateboard, wherein the cone member is configured to transfer torque to the front wheel.

4. The skateboard of claim 3, wherein the cone member is configured to transfer torque to the front wheel through frictional engagement with the front wheel.

5. The skateboard of claim 3, wherein the cone member is configured to transfer torque to the front wheel through geared engagement with the front wheel.

6. The skateboard of claim 2, further comprising one or more belts, wherein each of the one or more belts is configured to transfer torque from the one or more motors to the front wheel.

7. The skateboard of claim 2, wherein at least one of the one or more motors comprises a hub motor located at least partially within the front wheel.

8. The skateboard of claim 2, further comprising a remote control, wherein the remote control is operable to variably control acceleration of the skateboard.

9. The skateboard of claim 8, further comprising a control module in communication with the one or more motors, wherein the remote control is in wireless communication with the control module.

10. The skateboard of claim 8, wherein the remote control is configured to receive deceleration input from a user, wherein the deceleration input is operable to cause a ramping deceleration followed by a plateau deceleration of the skateboard.

11. The skateboard of claim 8, further comprising a control module in communication with the controller and the one or more motors, wherein the controller further comprises a reset button, wherein the reset button is operable to reset one or more circuits within the control module.

12. The skateboard of claim 8, wherein the controller further comprises a visual display, wherein the visual display is configured to display information relating to the skateboard.

13. The skateboard of claim 12, wherein the displayed information relates to one or more of speed, distance traveled, or positioning of the skateboard.

14. The skateboard of claim 12, further comprising a battery pack, wherein the displayed information relates to voltage level in the battery pack.

15. The skateboard of claim 1, wherein the deck has a slot formed at the front end of the deck wherein at least a portion of the front wheel is positioned within the slot.

16. The skateboard of claim 1, further comprising a suspension system coupled with the front wheel.

17. The skateboard of claim 1, further comprising a pair of headlamps.

18. The skateboard of claim 1, further comprising a rechargeable battery pack.

19. An electric skateboard, comprising:
(a) a deck having a front end, a back end, a top side, and a bottom side;
(b) a pair of wheels secured to a truck assembly, wherein the truck assembly is secured to the deck;
(c) a front wheel having a front wheel diameter;
(d) a deck height defined by the distance between the bottom side of the deck and the ground when the pair of wheels and the front wheel are in contact with the ground, wherein the deck height is less than the front wheel diameter;
(e) one or more motors in mechanical communication with the front wheel, wherein the one or more motors are operable to drive the front wheel;
(f) a control module in communication with the one or more motors, wherein the control module is operable to effect acceleration and deceleration of the one or more motors;
(g) a battery pack, wherein the battery pack is configured to provide power to the one or more motors; and
(h) a controller in wireless communication with the control module, wherein the controller is configured to receive user input, wherein the controller is further configured to transmit user input to the control module.

20. A skateboard system, comprising:
(a) plurality of skateboards, each skateboard comprising:
(i) a deck,
(ii) a plurality of wheels,
(iii) at least one motor,
(iv) at least one battery configured to provide power to the at least one motor,
(v) a control module in communication with the at least one motor, wherein the control module is operable to effect acceleration of the at least one motor; and
(b) a plurality of controllers, wherein each controller of the plurality of controllers is associated with a skateboard of the plurality of skateboards to create an associated set, wherein each controller is in wireless communication with the control module of its associated skateboard, wherein the controller is not operable to control any of the skateboards outside of its associated set.
